(19) United States
(12) Patent Application Publication
(10) Pub. No.: US 2019/0130078 A1
(43) Pub. Date: May 2, 2019

(54) PILL DISPENSER

(71) Applicant: JMH Consulting Group, LLC, Winchester, MA (US)

(72) Inventors: John Michael Herbert, Winchester, MA (US); Bryan R. Hotaling, Harvard, MA (US); Patrick J. Devine, Townsend, MA (US)

(73) Assignee: JMH Consulting Group, LLC, Winchester, MA (US)

(21) Appl. No.: 15/795,211

(22) Filed: Oct. 26, 2017

(51) Int. Cl. G06F 19/00; B65D 83/04; A61J 1/03; A61J 7/00; A61J 7/04

(52) U.S. Cl. CPC G06F 19/3462; B65D 83/0427; A61J 1/03; A61J 7/0076; A61J 2200/30; A61J 7/0418; A61J 7/0481; A61J 2200/74; A61J 7/0436

(57) ABSTRACT

A pill container and dispenser includes pill dispenser cap having a rotatable carousel with a pill receiving chamber. The carousel is rotatable between a position in which the chamber receives pills from a storage component of the pill dispenser, and a position in which the pill can be dispensed from the chamber to a user. The pill dispenser includes systems for detecting the dispensing of the pill, and systems for recording and/or reporting pill dispensing events to a mobile device or remote server to allow compliance tacking.

### FIELD

Disclosed embodiments relate to pill dispensers with dispensing tracking, medication scheduling, remote reporting, and other functionalities.

### DISCUSSION OF THE RELATED ART

There are a variety of pill dispensers, pill bottles, and pill organizers currently on the market, but as of the time of this writing, none have overcome the ubiquity of the snap on or twist on, transparent, orange pill bottle handed out by most major pharmacies. These containers provide an consistent and recognizable way of transporting and containing set amounts of medication, but provide little functionality besides child-proofing. It has been contemplated that the standard pill bottle could be improved.

### SUMMARY

According to one embodiment a pill dispenser includes a pill storage compartment to store a plurality of pills and a cap including an indicator. The cap further includes a rotatable carousel and a dispensing chamber with said rotatable carousel. The dispensing chamber is adapted to receive pills from the storage compartment, wherein the dispensing chamber includes a sensor that detects the presence of a pill in the dispensing chamber. The indicator is activated when the first sensor detects the presence of the pill in the dispensing chamber.

According to another embodiment, a pill dispenser includes a pill storage compartment to store a plurality of pills, a cap, and a control system that is adapted to wirelessly communicate information. The cap includes a dispensing chamber that prevents access to the pill storage compartment and dispenses pills via the dispensing chamber. The cap is rotated to a receiving position to introduce pills from the pill storage compartment into the dispensing chamber. The control system recognizes pill dispensing and triggers an alert indicator at key points during the process.

According to another embodiment, a pill dispenser includes a pill storage component that stores a plurality of pills, an at least partially rotatable cap, a control system, and a remote communication transmitter. The at least partially rotatable cap includes a dispensing chamber that is rotatable between a receiving position and a dispensing position, and is adapted to receive a limited number of pills from the storage compartment while in the receiving position. The control system recognizes and tracks dispensation of the pills. When the controller detects dispensation beyond a pre-set number of pills, the event is reported to a remote receiver using the remote communication transmitter.

In some embodiments of the pill dispenser are used as follows. The pill dispenser includes a storage compartment and a rotatable cap that includes a dispensing chamber. A user orients the pill dispenser such that a pill contained within the storage component of the pill dispenser enters the dispensing chamber. The user the rotates the cap to move the dispensing chamber to a dispensing position, where the dispensing chamber is no longer in communication with the storage component and instead aligns with a dispensing spout. Finally, the user removes a cover obstructing the dispensing spout such that the pill can exit there dispensing chamber and the pill dispenser.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a front perspective view of a pill dispenser according to one embodiment;

FIG. 2 is a front view of the pill dispenser of FIG. 1;

FIG. 3 is a top view of the pill dispenser of FIG. 1;

FIG. 4 is an exploded, front, top, perspective view of the pill dispenser of FIG. 1;

FIG. 5 is an exploded, front, bottom, perspective view of the pill dispenser of FIG. 1;

FIG. 6A is a cross-sectional view of the pill dispenser accepting a pill from the pill storage component;

FIG. 6B is a cross-sectional view of the pill dispenser with a pill in the dispensing chamber while in the receiving position;

FIG. 6C is a cross-sectional view of the pill dispenser with a pill in the dispensing chamber while in the dispensing position;

FIG. 6D is a cross-sectional view of the pill dispenser in the process of dispensing a pill; and

FIG. 7 shows a flow chart showing the origination and flow of data throughout the sensing/control system of the pill dispenser according to some embodiments.

### DETAILED DESCRIPTION

Prescription medications that include controlled substances are often regulated to prevent misuse and resale. For example, the total number of doses which a patient is permitted to be prescribed and/or receive in a single pharmacy visit is often limited. Such a regulatory arrangement forces the patient to repeatedly make visits to the doctor and/or the pharmacy, which is inconvenient and often difficult for people with health or transportation issues.

Patients are commonly prescribed set amounts of medication along with schedules for how frequently to take a certain dosage. For the vast majority of patients who aren't in situations involving round the clock medical supervision, it is up to them to follow the prescribed schedules and dosages. In these situations, doctors and pharmacies have no way of keeping track of whether the medication was taken at the correct time, in the correct dose, or if it was by the correct person.

Some medications, for example: anti-biotics are prescribed as a full regime where the patient is supposed to take each dose regardless of when the symptoms subside. Other medications, for example many opiates, are prescribed for patients to take as needed, but the amount dispensed per consult is strictly regulated. In each of these cases, it could be beneficial for prescribing doctors and primary care doctors to monitor medication consumption and compliance so that they are adequately informed for reasons including potential titration or identifying drug seekers.

Applicant has recognized that using a pill container which restricts and/or tracks the removal of pills from the container is beneficial to the patient not only with respect to dosage compliance, but also by obviating the need for limited prescription quantities.

According to one embodiment, a pill container permits only a certain number of pills to be removed from the container in a given amount of time. For example, the cap may include a lock that prevents opening of the container unless a prescribed amount of time has passed since the immediately prior pill withdrawal. Or the pill container may not contain any type of lock, but instead track and report the timing of pill removal. In some embodiments, the pill container is arranged to dispense one pill at a time, or some other specific number of pills at a time, so that the number of pills dispensed may be tracked.

Many pharmacies provide prescribed medication in well-known cylindrical pill containers that have snap on/off caps or twist on/off caps, often with child-resistant features. Applicant has recognized that employing compliance monitoring and pill dispensing technologies on pill bottles that look similar and operate similarly to existing pill bottles provides various advantages. For example, by using pill bottles which look similar to conventional pill bottles, patients can easily recognize the pill bottle. Familiarity with the operation (e.g, twist the cap to access the pills) may improve accessibility and compliance. Additionally, compatibility of components may be improved. For example, some pharmacy warehouses have specialized shelving and storage designed specifically for conventional pill bottles.

One effective manner of monitoring the dispensing of pills includes limiting the number of pills that can be dispensed at once. In some embodiments of the pill dispenser, the pill dispenser includes a pill storage component for storing pills, and a cap assembly. The cap assembly includes a rotatable carousel with a chamber that accepts individual pills or groups of pills. A user inverts the pill dispenser to cause one or more pills within the storage component to enter the chamber. The carousel is then rotated about a longitudinal axis of the cylindrical pill dispenser such that the chamber aligns with a pill spout in the top cover of the cap assembly.

With the carousel in this dispensing position, the user opens a flexible cover or other removable cover to allow the pill or pills to fall from the chamber, completing the dispensation. The user then rotates the carousel back to its original position in preparation for the next dispensing event. With such an arrangement, though the storage component may contain numerous pills, a user may only dispense as many pills as the chamber is sized to allow in one go.

In some embodiments of the pill dispenser, the carousel includes a torsion spring arranged such that rotating the carousel away from the receiving position tensions the spring. When the user releases the carousel after dispensing the pill, the carousel automatically rotates back to its original position due to the tension in the spring.

To prevent user access to all of the pills at once, some embodiments of the pill dispenser include a cap assembly that is permanently attached to the storage component such that the cap assembly and/or storage container must be broken to access all of the pills at once. Alternately, in some embodiments, the cap assembly requires a special tool to separate the cap assembly from the storage component.

According to some embodiments, the pill container detects and records when pills enter the chamber. Because the chamber dispenses a consistent number of pills with each dispensation (which may be a single pill in some embodiments), the total number of pills dispensed may be tracked by recording the number of times that one or more pills are detected in the chamber. In some embodiments, the cap assembly further includes a controller that receives input from one or more sensors that monitor the occupation status of the chamber. The sensors report to the controller when a pill (or pills) is detected in the chamber, and report again when the chamber is emptied due to dispensation, altogether indicating one round of pill dispensation.

To ensure that the change in status was not from the pill re-entering the storage component, some embodiments of the pill dispenser use at least two sensors located on different sides of the carousel. A first sensor or set of sensors detects occupation of the chamber while the carousel is oriented such that the chamber can receive a pill from the storage component, and a second sensor is oriented to detect the occupation state of the chamber when the carousel is in the dispensing position. If the controller receives information that the chamber is full from the first sensor, and then receives information that the chamber is empty from the second sensor, it can determine that a pill was dispensed. If the first sensor indicates occupation, and then non-occupation before the second sensor detects the presence of the chamber at all, then the pill fell back into the storage component. If the first sensor indicates occupation and then the user opts against dispensing a pill and resets the carousel by continuing to rotate back to the receiving position, the second sensor will indicate occupation of the chamber followed immediately by the first sensor detecting an occupied chamber without the second sensor detecting a loss of occupation. This would alert the controller that dispensation event was cancelled.

Some embodiments of the pill dispenser include one or more sensors that rotate with the carousel and additional sensors that remain static relative to the chamber. In this embodiment, the cap assembly further includes a rotary encoder or other sensor that can detect and interpret rotation state that reports the rotational state of the carousel to the controller. In these embodiments, the controller interprets the sequence of pill detection events from the chamber and the carousel's rotation to determine when a pill is dispensed. For instance, if the chamber indicates that a pill is present, the rotary encoder reports rotation to the dispensing position, and subsequently the chamber reports that it is no longer holding a pill, the controller records an instance of dispensation.

It should be understood that although specific combinations of sensor systems and pill dispensation detecting methods have been described above, the current disclosure is not limited to the described systems. The pill dispenser may include more or fewer sensors of different types and functions that work alone or in tandem to indicate when pills have been dispensed. In addition, not all of the disclosed features are necessarily required to be present, and various features may be used in various combinations. After detecting dispensation information, the controller notes the time and date of each dispensation and transmits the information via a signal transmitter to a remote server or mobile device, according to some embodiments. In these embodiments, the pill dispenser may include a wireless communication system such as a Bluetooth transmitter/receiver, a Wi-Fi transmitter/receiver, and/or any other suitable communication system. The pill dispenser is further associated with a mobile app or computer program that accepts each recorded instance broadcast by the pill dispenser. The program or app takes each recorded instance and creates a history of dispensation, which can be representative of a user's compliance schedule with the medication in question.

In some embodiments of the pill dispenser, the cap assembly includes a local digital storage medium that saves the dispensation events recorded by the controller, and a local battery or other power source to power the system. These embodiments may further include input/output media ports such as USB ports, that may be used to transfer data between the local digital storage medium and another device. In these embodiments, the pill dispenser may also attempt to broadcast the event to a remote server or mobile device regardless of whether the event is saved locally or not. As the user dispenses doses over the course of the prescribed regime, each recorded instance is gathered by the controller to form a recorded history of when the user took each pill.

Using this history, a caregiver can determine if the patient was compliant with each scheduled dose. Additionally, a caregiver can also determine if a user is erring in consumption frequency, or if a user is dispensing too frequently and potentially abusing the medication. A caregiver or pharmacist can also see if the number of dispensation events does not match the remaining dosage. For instance, if a user were to attempt to abuse or sell a narcotic and returned to a pharmacy or doctor's office to request a refill, it would be apparent to the caregiver or pharmacist that the number of attempted dispensations was either too frequent or, if the user found another way to remove the pills, that the dispensations do not match the number of remaining pills.

The pill dispenser may provide additional functionality. In some embodiments, the cap assembly further includes one or more indicator systems. For convenience, the disclosure describes LED lights as indicators, but it should be understood that the indicators may be any suitable feature that gets a user's attention, including but not limited to a vibration generator, a sound source, a heat generator, a non-LED light source, or a combination of the above. The LED lights may be connected to the controller such that when the pill first enters a chamber, one indicator, such as a red light, turns on to indicate that the chamber is occupied. When the user has fully rotated the carousel such that the chamber is now in the dispensing position, a second indicator, such as a green light, is activated indicating to the user that they can extract the pill. When the pill is detected to have left the chamber, the lights turn off.

Other systems of notification and feedback may be used. For instance, only one indicator may flash when the pill first enters the chamber, and the indicator may flash again when the chamber has been rotated to the dispensing position. Alternatively, for medication schedules that require multiple doses, one of the indicators may remain activated until the appropriate number of pills have been dispensed. It should be understood that the current disclosure is not limited to any particular notification or feedback system.

In some embodiments, the indicators alert users at predetermined times that they should take their medication. For example, in embodiments with local memory storage, when the prescription is being filled, a pharmacist may program a prescribed schedule for taking medication. After prescription fulfillment, at the specified times, the controller activates at least one of the indicators, alerting the user that it is time to take the medication.

For embodiments that include a mobile device or remote server that communicates with the pill dispenser, the prescribed schedule may be saved on the mobile device or saved on the remote server. The mobile device and remote server may send a signal to the pill dispenser at the specified times. The controller receives these signals, and triggers the indicator.

In embodiments with both local memory storage and connection functionality with a mobile device, instead of activating an indicator at predetermined times according to the pre-programed schedule, the controller instead may broadcast a signal to the mobile device. An alert may then appear on, or be generated by, the mobile device to alert the user take the medication. The schedule may be stored only on the mobile device such that the mobile device alerts the user without involving the pill dispenser at all.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

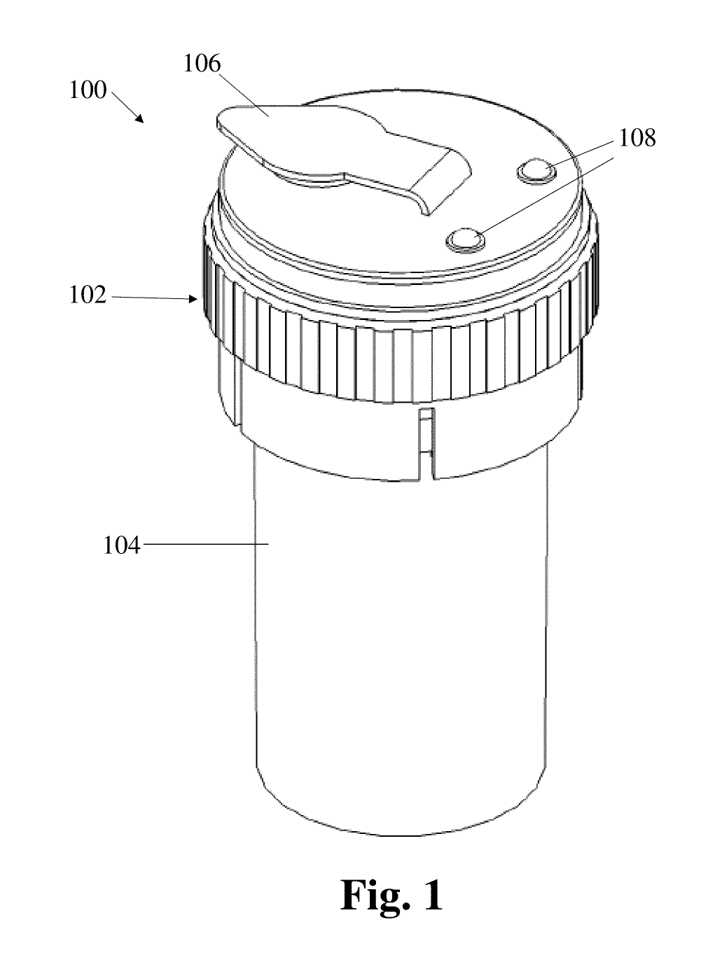

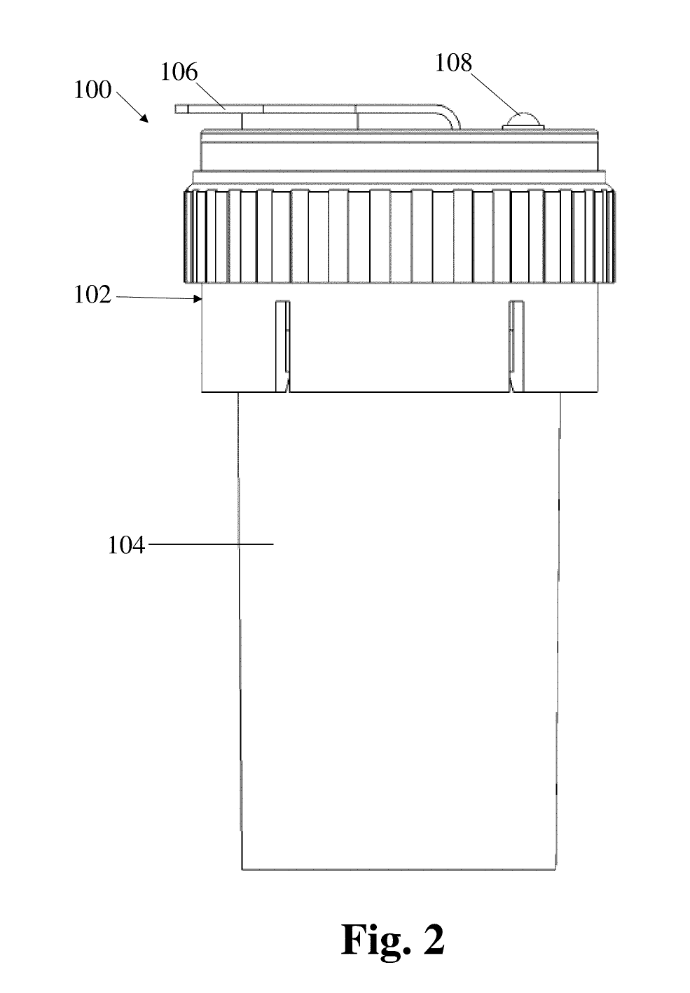

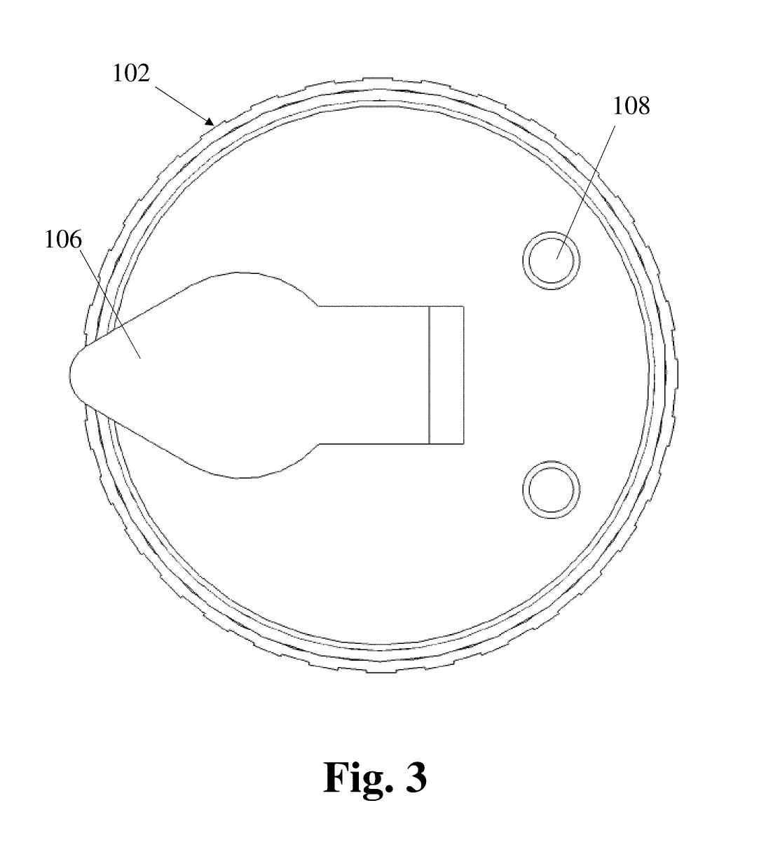

FIGS. 1-3 show one embodiment of a pill dispenser 100. A cap assembly 102 is attached on the top of a storage component 104 and obstructs direct access to the contents of storage component 104. A top cover 402 of cap assembly includes a flexible cover 106 that is pivotably attached to a top surface of cap assembly 102 at one end, and removably covers the pill spout at the other end. Indicators 108 are provided. In the illustrated embodiment, indicators 108 include a pair of LED lights. However, as mentioned above, indicators 108 may be any suitable system capable of getting a user's attention. In this embodiment, cap assembly 102 is both a twist-on cap and a snap-on cap as will be described further below. However, cap assembly 102 may be only a snap-on cap or only a twist-on cap, or may be permanently attached to storage component 104.

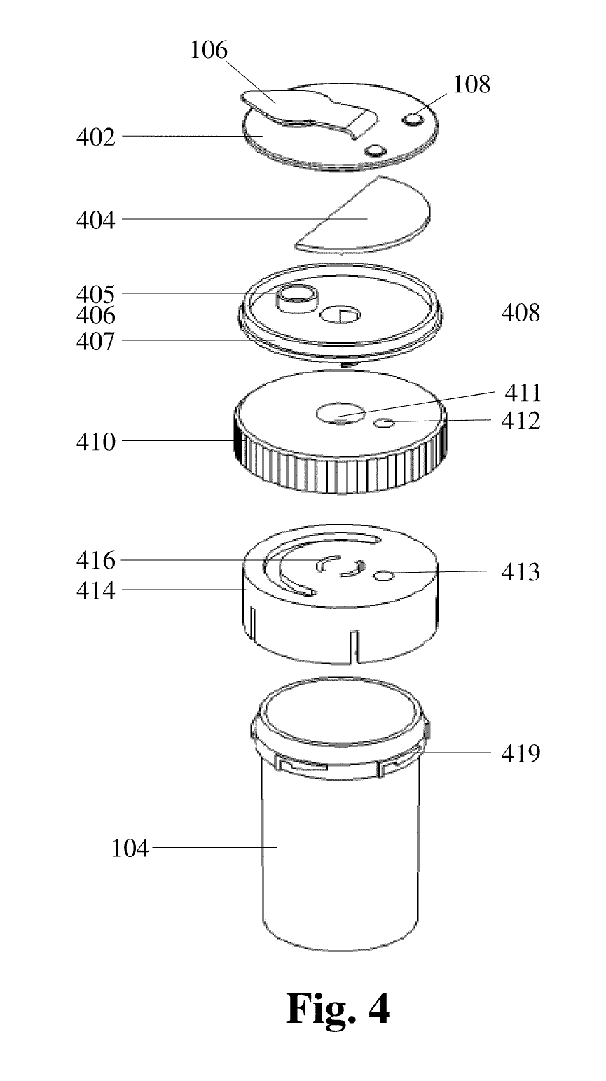

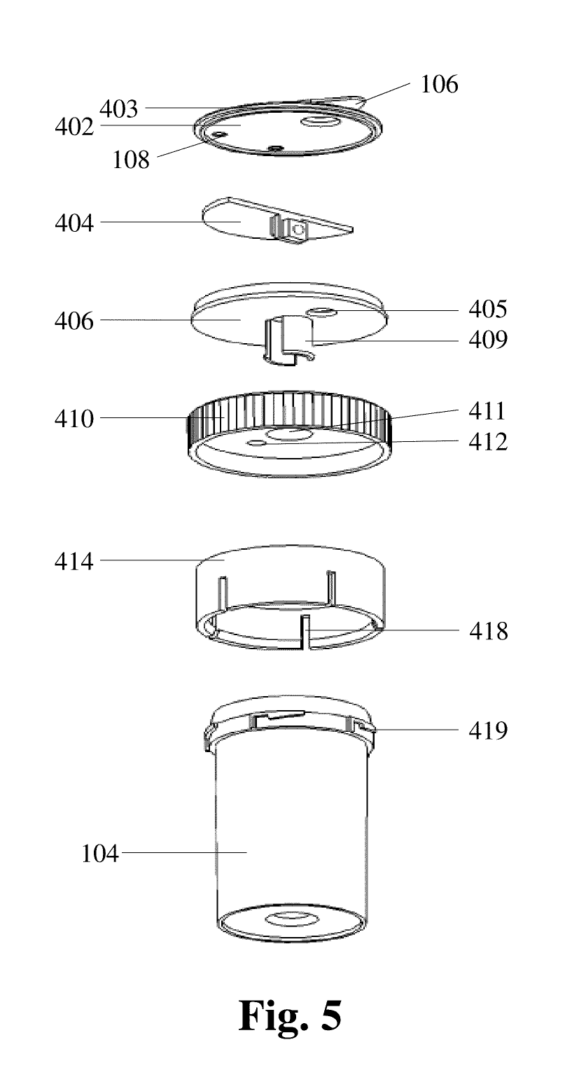

FIGS. 4 and 5 show a top perspective exploded view and a bottom perspective exploded view of pill dispenser 100. Track features 419 on storage component 104 interface with corresponding features on the inside of a snap-on cap 414 such that the cap snaps over the track features 419, and can be rotated clockwise to lock the snap-on cap in place. Snap-on cap 414 includes a through-hole 413, which allows pills from within storage component 104 to pass through. Also positioned on snap-on cap 414 are attachment channels 416 which accept attachment feature 409 as described below.

A carousel 410 sits on top of and rotates freely on snap-on cap 414. The outside edges of carousel 410 include surface features that assist gripping of the carousel for rotation. The pill chamber is housed within carousel 410, and chamber 412 within carousel 410 accepts pills from storage component 104 through through-hole 413. Chamber 412 may be sized as suitable for a prescribed dosage. For example, if a prescribed regimen required a single pill, chamber 412 may be just large enough for that pill. Similarly, if a regiment requires multiple pills, chamber 412 and through-hole 413 may be sized to contain multiple pills for a single dispensation event. In some embodiments, through-hole 413 may be gated with protruding features to guide individual pills into the through-hole, or prevent multiple pills from becoming jammed in the entrance.

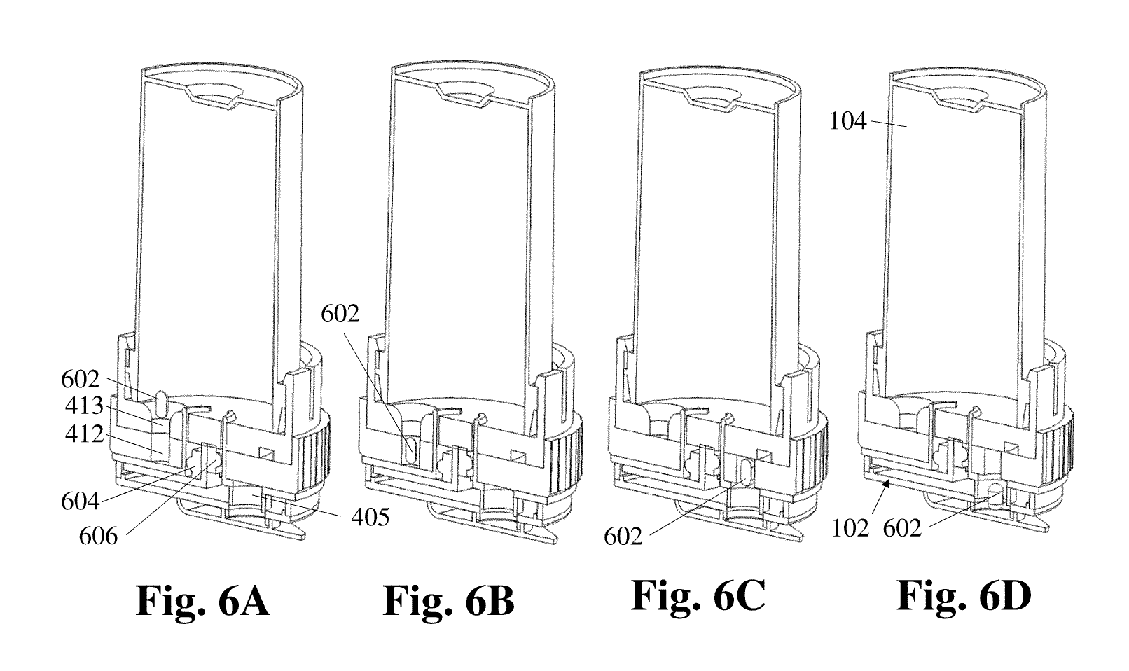

A dispensing lid 406 is positioned atop carousel 410, an and attachment feature such as a two-pronged post 409 extends through a carousel channel 411 to interface with attachment channels 416. Dispensing lid 406 has a rim 407 around its perimeter. Within rim 407 sits a circuit board 404, which may include a controller, a power source such as a battery, and a transmitter and/or a receiver. As seen in FIGS. 6A-6D, a chamber sensor 604 and a dispensing sensor 606 extend from the bottom of circuit board 404 and sit within carousel access port 408 on dispensing lid 406.

Top cover 402 has lips 403 on its bottom surface which interface with rim 407 to attach the top cover to the dispensing lid such that flexible cover 106 aligns with pill spout 405 on the dispensing lid.

FIGS. 6A-6D show a sequence of cross-sectional views of the pill dispenser during the process of dispensing a pill. FIG. 6A shows the pill dispenser in the receiving position, as a pill 602 is entering the chamber 412 via through-hole 413. As seen in FIG. 6B, once the pill 602 is within the chamber, chamber sensor 604 detects the presence of the pill and in some embodiments triggers an indicator 108 via the controller to alert the user that a pill has entered the chamber. The user then grips and rotates the carousel until the carousel arrives at the dispensing position shown in FIG. 6C. In the dispensing position, dispensing sensor 606 detects that the chamber containing the pill is in the dispensing position. Upon receiving this information, the controller triggers a second indicator 108 in some embodiments to alert the user to open flexible cover 106 to receive pill 602. Dispensing sensor 606 detects that pill 602 has left the chamber, and the dispensing event may be recorded and/or may be communicated to a mobile device or remote server. In some embodiments, the user rotates the carousel back to its original position, or, in other embodiments, a torsion spring causes the carousel to return. If the pill 602 did not leave the chamber as determined by dispensing sensor 606, the event is not recorded. In this situation, once the carousel returns to its original position, the pill 602 falls back through through-hole 413 and into storage component 104. Chamber sensor 604 and dispensing sensor 606 may be a proximity sensor, weight sensor, IR sensor, or any other suitable sensor to sense the physical presence of a pill.

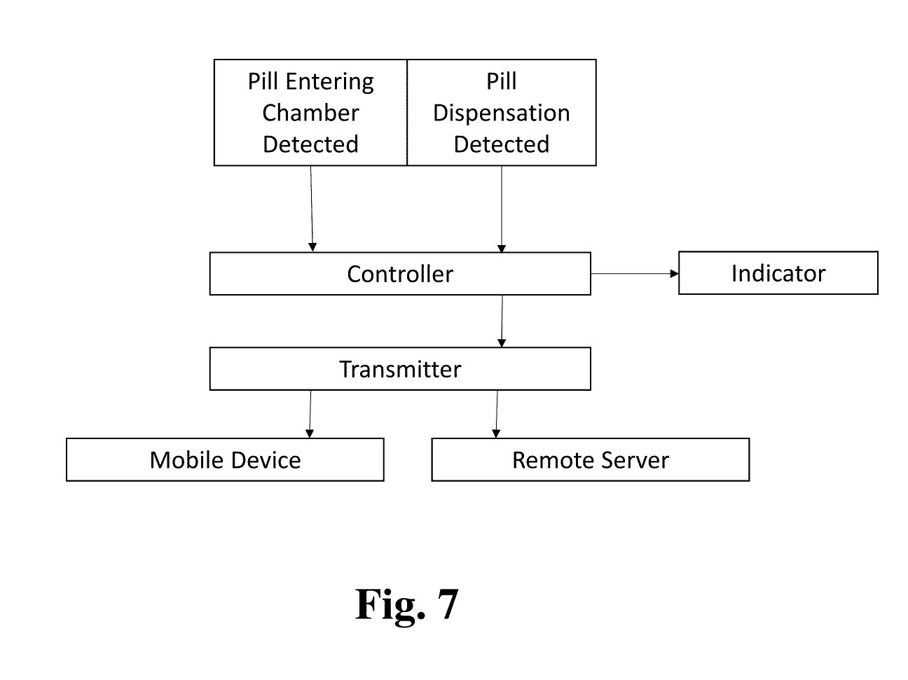

FIG. 7 shows a flow chart describing the flow of information and data recorded by the sensing/control system throughout operation of the pill dispenser 100 in some embodiments. When a pill 602 enters the chamber 412 and is dispensed, the chamber sensor 604 and dispensing sensor 606 detect each event ,respectively. In some embodiments, each respective event is reported by an indicator 108 on top cover 402. When a pill is dispensed, the controller notes the event and sends information to the transmitter. The transmitter then sends the information to a mobile device or a remote server. The transmitter may use Bluetooth technology or any other suitable type of transmitter, and ultimately communicate with the mobile device or remote server via the Internet. The remote server or mobile device may each include software that accepts and records the information to create a pill dispensation history that can be reviewed by the prescriber or a caregiver.

The cap assembly may be equipped with a lock, for example, the cap assembly may include a push-pull solenoid that extends a latch into a receiving recess on the storage component, preventing the cap assembly from rotating relative to the storage component, limiting access to the pills contained within. The current disclosure is not limited to any specific locking mechanism, and a lock need not be present in various embodiments.

In some embodiments, the mobile device may be used to send locking and unlocking commands to the controller, which in turn actuates the lock. The cap assembly may remain actively locked for most of a given time period, and be unlocked for dispensation via a mobile device during a specified time window around a prescribed dispensation time. Similarly, a caregiver or a user could remotely send a lock command to the pill dispenser to prevent access if the dispenser is stolen or expired.

In some embodiments utilizing a mobile device, the pill dispenser may be unlocked for dispensation by entering a password and/or through biometric authentication. An application loaded on the mobile device may be configured to accept a fingerprint, take a facial scan, apply voice recognition, or otherwise ensure that an authorized user is the person attempting to access the pill dispenser. When the user is authenticated, the mobile device sends an unlock command to the controller, which then actuates the lock, allowing dispensation to occur.

In some embodiments of the pill dispenser, a caregiver or prescriber may desire a higher level of security, and an application (e.g., on a mobile device) may be used to record video of the pill being dispensed and/or consumed. In some embodiments, the caregiver may be able to select an option that requests or requires a user to start recording a video in order for the pill container to unlock. For example, the user's mobile device application may receive an indication that videos are required, and when it is time to access the pill container, a reminder may be displayed on the mobile device. Once a video recording is started, the mobile device may send an instruction to the pill container to permit opening. Regardless of whether the pill container has a lock, the application that is used to record dispensation history on the mobile device may be configured provide a time and date stamp for each recorded video, and may e configured to associate each video with each dispensation event, for example with a unique code. In these embodiments, when a caregiver reviews the dispensation history, he or she can additionally view the videos the ensure that the user was compliant with the medication schedule. In other embodiments, the software or application may send the videos and the dispensation history to a remote server for storage and management.

The cap assembly may shaped and sized such that it can fit over a typical pill bottle used by most pharmacies. This design may allow a caregiver or pharmacist to maintain their current supply channels, and opt to use a pill dispenser of the present disclosure when instructed by the prescriber, or if the prescribed medication is particularly dependent on compliance or is often abused. In addition, the familiar form factor and appearance of the pill container may be easier for a user to recognize when looking for the container.

While the cap assembly may be adapted to work with typical cylindrical, plastic pill bottles, the cap assembly may be used with containers made of different materials and/or containers with different shapes. For instance, some embodiments of the pill dispenser include a storage component made of stainless steel or another material that is difficult to penetrate. These embodiments make it particularly difficult to access the pills within the storage component except via the cap assembly, providing another level of prevention against potential medication abuse.

Another embodiment of the pill dispenser utilizes a storage component shaped like a common pill bottle, but the walls of the bottle are lined with electrically conducting filaments such that the filaments are contained entirely within the walls of the storage component. In these embodiments, each filament creates a complete circuit, and current within the circuit is detected by the controller via an ammeter. If the storage component is compromised, the filaments are easily broken, breaking the electric circuit. In such a situation, the controller may register this event to a local digital memory storage component, or report to a remote server depending on the embodiment. With such an arrangement, a caregiver or pharmacist is made aware of the compromised container and can take further action if appropriate.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

As is apparent from the foregoing examples, a local digital storage medium may retain information for a sufficient time to provide computer-executable instructions in a non-transitory form. Such a local digital storage media can be transportable, such that the program or programs stored thereon can be loaded onto one or more different computers or other processors to implement various aspects of the present disclosure as discussed above. As used herein, the term “local digital storage medium” encompasses only a non-transitory computer-readable medium that can be considered to be a manufacture (i.e., article of manufacture) or a machine. Alternatively or additionally, the disclosure may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present disclosure as discussed above. Additionally, it should be appreciated that according to one aspect of this embodiment, one or more computer programs that when executed perform methods of the present disclosure need not reside on a single computer or processor, but may be distributed in a modular fashion amongst a number of different computers or processors to implement various aspects of the present disclosure.

For purposes herein, the term “pill” is intended to include any type of medication having a solid or semi-solid outer surface which maintains its shape during normal handling. For example, the term “pill” is intended to include tablets, capsules, caplets, lozenges, suppositories, chewing gum pieces, as well as other types of medication intended for patient ingestion.

Various aspects of the present disclosure may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Further, some actions are described as being performed by a user. It should be appreciated that a user need not be a single individual, and that in some embodiments, actions attributable to a user may be performed by a team of individuals and/or an individual in combination with computer-assisted tools or other mechanisms.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

What is claimed is:

1. A pill dispenser comprising:
a pill storage compartment to store a plurality of pills;
a cap including a rotatable carousel and a dispensing chamber within the rotatable carousel, the dispensing chamber being adapted to receive pills from the storage compartment, wherein the dispensing chamber includes a first sensor that detects the presence of a pill in the dispensing chamber; and
an indicator that is activated when the first sensor detects the presence of the pill in the dispensing chamber.

2. The pill dispenser of claim 1, wherein the indicator is a light.

3. The pill dispenser of claim 1, wherein the first sensor comprises at least one of a weight sensor, a IR scanner, and a proximity sensor.

4. The pill dispenser of claim 1, wherein the dispensing chamber is rotated with the carousel, and rotating the carousel disposes the dispensing chamber in a dispensing position, in which a pill can be dispensed from the pill dispenser.

5. The pill dispenser of claim 1, wherein the cap includes a second sensor that detects when the chamber is in the dispensing position and contains a pill, and when the chamber is in the dispensing position and no longer contains a pill.

6. The pill dispenser of claim 1, wherein the pill dispenser further includes a control system that records when a pill is dispensed.

7. A pill dispenser comprising:
a pill storage compartment configured to store a plurality of pills;
a cap including a dispensing chamber, wherein the cap prevents access to the pill storage compartment and dispenses pills via the dispensing chamber, and the cap is rotatable to a receiving position to permit a pill to move from the storage compartment into the dispensing chamber; and
a sensor and a controller adapted to recognize when a pill is dispensed, wherein, in response to a dispensing of a pill, the controller sends wirelessly sends a dispensation indication.

8. The pill dispenser of claim 7, wherein the controller reports pill dispensing records to a mobile device.

9. The pill dispenser of claim 7, wherein the controller reports information to a remote server.

10. The pill dispenser of claim 8, wherein the controller triggers alerts on the mobile device at specified time intervals.

11. The pill storage compartment of claim 7, wherein specified permitted dispensation time intervals are stored on the controller, and the controller wirelessly sends a notification if the controller detects a pill dispensation outside of the specified time intervals.

12. The pill dispenser of claim 7, wherein the controller includes a local data storage medium, and pill dispensing records are saved to the local data storage medium.

13. The pill dispenser of claim 7, wherein the cap includes a rotatable carousel that contains the dispensing chamber, such that rotating the carousel rotates the dispensing chamber about a longitudinal axis of the pill dispenser.

14. The pill dispenser of claim 8, wherein when the carousel is rotated to a dispensing position, the dispensing chamber enters a configuration where the pill can be dispensed from the pill dispenser to a user.

15. A method of dispensing a pill from a pill dispenser, the pill dispenser including a storage compartment and a rotatable cap, the rotatable cap including a dispensing chamber, the method comprising:
orienting the pill dispenser such that a pill contained within the storage component of the pill dispenser enters the dispensing chamber;
rotating the cap to move the dispensing chamber to a dispensing position where the dispensing chamber is no longer in communication with the storage component and the dispensing chamber aligns with an opening in a dispensing spout; and
moving a dispensing spout cover such that the pill can exit the dispensing chamber.

16. The method of claim 15, further including the step of a first sensor detecting the presence of the pill in the dispensing chamber.

17. The method of claim 16, further including the step of a second sensor detecting that the dispensing chamber is in the dispensing position and contains a pill.

18. The method of claim 17, further including the step of the second sensor detecting that the pill has exited the dispensing chamber and pill dispenser.

19. The method of claim 18, further including the step of a control system reporting the dispensing of a pill to a mobile device via a remote communication transmitter within the cap.

20. The method of claim 17, further including the step of a control system reporting the dispensing of a pill to a remote server via a remote communication transmitter within the cap.

21. A pill dispenser comprising:
a pill storage compartment adapted to store a plurality of pills;
a rotatable cap including a dispensing chamber, the dispensing chamber being rotatable between a receiving position and a dispensing position, wherein, in the receiving position, the dispensing chamber is adapted to receive one or more pills from the storage compartment, and adapted to dispense the one or more pills to a user from the dispensing chamber;
a control system that recognizes and tracks dispensation of pills; and
a wireless transmitter, wherein if the controller detects pill dispensation beyond a specified number of pills within a specified amount of time, the wireless transmitter wirelessly transmits a communication.

22. The pill dispenser of claim 21, wherein the communication is received by a mobile device.

23. The pill dispenser of claim 21, wherein the communication is received by a remote server.

24. The pill dispenser of claim 21, wherein the pill storage compartment and control system are adapted to detect if the pill storage compartment is compromised.

25. The pill dispenser of claim 24, wherein the control system sends an indication of the compromise via the wireless transmitter.

26. The pill dispenser of claim 21, further comprising a first sensor within the dispensing chamber which detects the presence of the one or more pills.

27. The pill dispenser of claim 26, wherein the cap includes a second sensor that detects when the dispensing chamber is in the dispensing position and contains at least one pill, and when the chamber is in the dispensing position and does not contain a pill.
